(19) United States
(12) Patent Application Publication
(10) Pub. No.: US 2008/0316507 A1
(43) Pub. Date: Dec. 25, 2008

(54) Printing apparatus and printing method thereof

(75) Inventor: Chen-Yang Ying, Kaohsiung City (TW)

Correspondence Address: REED SMITH LLP, Suite 1400, 3110 Fairview Park Drive, Falls Church, VA, 22042, US

(73) Assignee: Hi-Touch Imaging Technologies Co., Ltd.

(21) Appl. No.: 11/882,900

(22) Filed: Aug. 7, 2007

(30) Foreign Application Priority Data
Jun. 22, 2007 (TW) 096122436

(51) Int. Cl. G06F 3/12

(52) U.S. Cl. 358/1.1

(57) ABSTRACT

The invention provides a printing apparatus. The printing apparatus is used for printing a content to be printed on an object. A surface of the object-includes a non-printable area. The printing apparatus includes a scanning/retrieving module, an adjusting module, and a printing module. The scanning/retrieving module is used for scanning the surface of the object and retrieving the position information of the non-printable area. The adjusting module is used for adjusting the content to be printed to generate an adjusted content based on the position information. The printing module is used for printing the adjusted content on the printable area of the surface. The printable area is different from the non-printable area.

### BACKGROUND OF THE INVENTION

1. Field of the Invention

The invention relates to a printing apparatus and, more particularly, to a printing apparatus and a printing method used for automatic mass-printing.

2. Description of the Prior Art

In recent years, with the vigorous development of digital image technologies, more and more digital image related applications including the device and method of printing digital images on all kinds of object, can be found on the market. For example, in order to increase the uniqueness of the product to attract consumers, many finance corporations promote credit cards on which various images can be printed. Exquisite texts or images are also printed on cards for different purposes, for instance, magnetic stripe cards, IC cards, metro cards, and prepaid cards.

In general, the above-mentioned texts or images should not cover the inductive region on the card (e.g., the magnetic stripe on the magnetic stripe card or the chip on the IC card), so that the inductive function of the card will not be affected. However, because of the errors made by the card producers during the manufacturing process, the position of the non-printable area (e.g., the magnetic stripe or the chip) of each card may be slightly different. In order to precisely print the image or the text on the card and avoid these non-printable areas, some producers even have the cards examined by naked eyes and adjust them one by one. It is by all means a complete waste of manpower and time, and it could not facilitate mass production.

There have been some inventions providing the methods of adjusting the printing apparatus in a mechanical way to solve the above problem. For example, Taiwan patent numbered I155893 discloses a method of taking the image of certain object to be printed first, and then comparing the taken image with a standard reference image. Afterward, the position of the printing equipment or the object to be printed is adjusted based on the comparing results. The drawback of the prior art is that the mechanical equipment used for adjusting the printing equipment or the object to be printed is easily worn out through frequent uses. Besides, it is time-consuming to adjust the hardware in the mechanical way. Therefore, the above-mentioned method is not applicable for mass printing.

Accordingly, the main goal of the invention is to provide a printing apparatus and a printing method to solve the problems above.

### SUMMARY OF THE INVENTION

A scope of the invention is to provide a printing apparatus and a printing method thereof. An embodiment based on the invention is a printing apparatus for printing a content to be printed on an object. A surface of the object includes a non-printable area. The printing apparatus includes a scanning/retrieving module, an adjusting module, and a printing module. The scanning/retrieving module is used for scanning the surface of the object and retrieving position information of the non-printable area. The adjusting module is electrically connected to the scanning/retrieving module, and is used for adjusting the content to be printed to generate an adjusted content based on the position information. The printing module is electrically connected to the adjusting module, and is used for printing the adjusted content on the printable area of the surface. The printable area is different from the non-printable area.

Compared to the prior arts, in the printing apparatus and the printing method based on the invention, the content to be printed is directly adjusted in an electrical way to reach a goal of avoid printing the image or text on the non-printable area. Because the printing equipment does not need to be adjusted in the printing apparatus of the invention, the inconvenience of operating mechanical adjustment can be avoided, and the printing efficiency can also be highly improved. It is beneficial for massive auto-printing.

The advantage and spirit of the invention may be understood by the following recitations together with the appended drawings.

### BRIEF DESCRIPTION OF THE APPENDED DRAWINGS

FIG. 1 is a functional block diagram of the printing apparatus of the first embodiment based on the invention.

FIG. 2 is a functional block diagram of the printing apparatus further including an auto-delivering module.

FIG. 3 is a flow diagram of the printing method according to the second embodiment of the invention.

### DETAILED DESCRIPTION OF THE INVENTION

The first embodiment according to the invention is a printing apparatus. The printing apparatus is used for printing a content to be printed on an object. A surface of the object includes a non-printable area. In practical applications, the object can be a piece of paper, a card, or an optical storage media (e.g., compact disk-recordable). The content to be printed can include all kinds of text and/or images. Taking a credit-card for an example, the non-printable area may include a magnetic stripe or a chip.

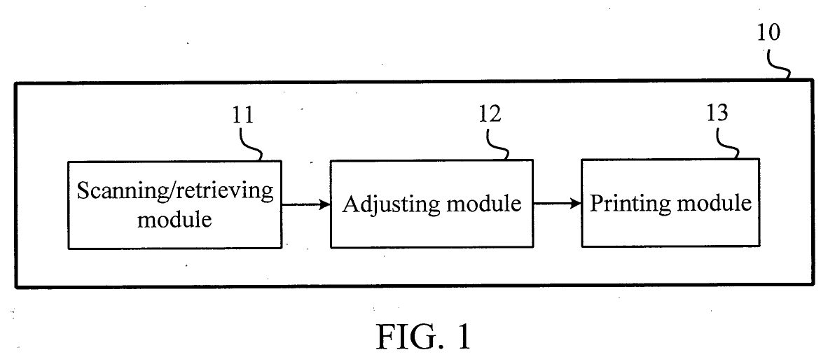

Please refers to FIG. 1, FIG. 1 is a functional block diagram of the printing apparatus of the first embodiment based on the invention. As shown in FIG. 1, the printing apparatus 10 includes a scanning/retrieving module 11, an adjusting module 12, and a printing module 13. The scanning/retrieving module 11 is used for scanning the surface of the object and retrieving position information of the non-printable area. The adjusting module 12 is electrically connected to the scanning/retrieving module 11, and is used for adjusting the content to be printed to generate an adjusted content based on the position information. The printing module 13 is electrically connected to the adjusting module 12, and is used for printing the adjusted content on a printable area of the surface. It should be noticed that the printable area is different from the non-printable area. That is to say, the content to be printed will not affect or cover the non-printable area.

In practical applications, the scanning/retrieving module 11 can include a scanner, a digital camera, or a reflective sensing device. And, the position information can include a relative coordinate, a length, a width, an angle of inclination, or an area of the non-printable area. In addition, the adjusted content can be printed by the printing module 13 with a thermal transferring printing-method or an inkjet printing method.

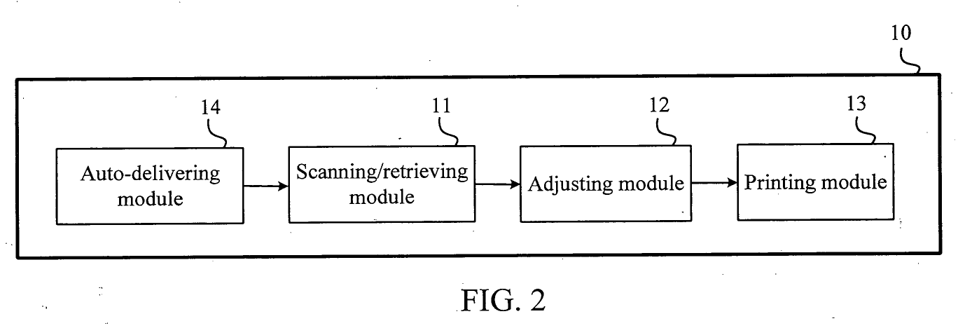

As shown in FIG. 2, the printing apparatus 10 can further include an auto-delivering module 14. The auto-delivering module 14 is electrically connected to the scanning/retrieving module 11, and is used for automatically delivering the object into a scanning/retrieving range of the scanning/retrieving module 11. When the amount of the object is more than one, the auto-delivering module 14 can automatically deliver all objects into the scanning/retrieving range of the scanning/retrieving module 11. In this way, the printing apparatus 10 can print a large amount of objects in batch.

For example, a cartoon image is to be printed on one hundred IC cards by the operator. When the first IC card is automatically delivered into a scanning/retrieving range of the scanning/retrieving module 11, the scanning/retrieving module 11 can scan the surface of the IC card and retrieve the position of the chip relative to the edge of the card. Then, the adjusting module 12 will adjust the cartoon image to generate an adjusted cartoon image based on the position of the chip on the card. If the position of the chip is slightly toward the left/right, the adjusting module 12 will correspondingly adjust the cartoon image to the left/right.

Afterward, the printing module 13 will print the adjusted cartoon image on the printable area of the surface of the IC card. In order to avoid affecting the functions of the IC card, the position of the chip is not included in the printable area. After the first IC card is printed, the cartoon image can be printed on the second IC card, the third IC card, . . . , and the hundredth IC card in the same way.

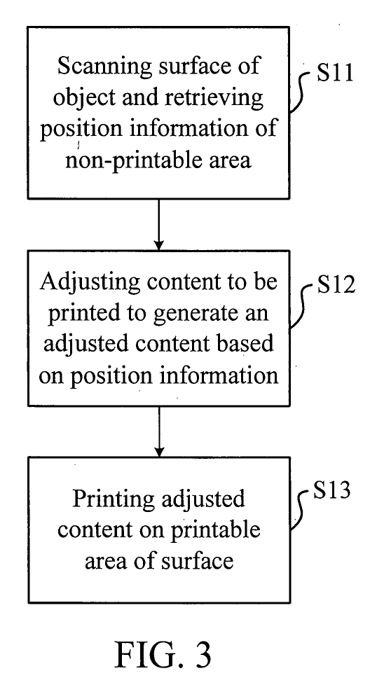

The second embodiment according to the invention is a printing method. Please refers to FIG. 3, FIG. 3 is a flowchart of the printing method. As shown in FIG. 3, step S11 is firstly performed for scanning the surface of the object and retrieving position information of the non-printable area. Then, step S12 is performed for adjusting the content to be printed to generate an adjusted content based on the position information. Thirdly, step S13 is performed for printing the adjusted content on the printable area of the surface. And, the printable area is different from the non-printable area.

In addition, after the adjusted content is generated through operating the step S12, the adjusted content can be further stored by the method for the statistic reference in later use.

Compared to prior arts, the printing apparatus and printing method thereof based on the invention can automatically detect and avoid printing the image and the text on the non-printable area of the object (e.g., the magnetic stripe on the magnetic stripe card or a chip on the IC card), and is also applicable for automatically printing a large amount of objects. Thus, the printing apparatus and printing method thereof based on the invention can save a great deal of manpower and time to largely improve the printing efficiency. In addition, in the printing apparatus and printing method thereof based on the invention, the content to be printed, instead of the printing equipment, is adjusted to avoid the drawback and inconvenience of mechanical adjustment.

With the above example and explanation, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A printing apparatus for printing a content to be printed on an object, a surface of the object having a non-printable area, the printing apparatus comprising:
a scanning/retrieving module for scanning the surface of the object and retrieving position information of the non-printable area;
an adjusting module, electrically connected to the scanning/retrieving module, for adjusting the content to be printed to generate an adjusted content based on the position information; and
a printing module, electrically connected to the adjusting module, for printing the adjusted content on a printable area of the surface, the printable area is different from the non-printable area.

2. The printing apparatus of claim 1, wherein the content to be printed comprises text and/or an image.

3. The printing apparatus of claim 1, wherein the object is a piece of paper, a card, or an optical storage media.

4. The printing apparatus of claim 1, wherein the non-printable area comprises a magnetic stripe or a chip.

5. The printing apparatus of claim 1, wherein the scanning/retrieving module comprises a scanner, a digital camera, or a reflective sensing device.

6. The printing apparatus of claim 1, wherein the position information comprises a relative coordinate, a length, a width, an angle of inclination, or an area of the non-printable area.

7. The printing apparatus of claim 1, wherein the adjusted content is printed by the printing module with a thermal-transferring printing method or an inkjet printing method.

8. The printing apparatus of claim 1, further comprising:
an auto-delivering module, electrically connected to the scanning/retrieving module, for automatically delivering the object into a scanning/retrieving range of the scanning/retrieving module.

9. The printing apparatus of claim 1, further comprising:
a storage module, electrically connected to the adjusting module, for storing the adjusted content.

10. A printing method for printing a content to be printed on an object, a surface of the object with a non-printable area, the printing method comprising the steps of:
scanning the surface of the object and retrieving position information of the non-printable area;
adjusting the content to be printed to generate an adjusted content based on the position information; and
printing the adjusted content on a printable area of the surface, the printable area is different from the non-printable area.

11. The printing method of claim 10, wherein the content to be printed comprises text and/or an image.

12. The printing method of claim 10, wherein the object is a paper, a card, or an optical storage media.

13. The printing method of claim 10, wherein the non-printable area comprises a magnetic stripe or a chip.

14. The printing method of claim 10, wherein the position information comprises a relative coordinate, a length, a width, an angle of inclination, or an area of the non-printable area.

15. The printing method of claim 10, further comprising the step of:
storing the adjusted content after the adjusted content is generated.
